(19) United States
(12) Patent Application Publication
(10) Pub. No.: US 2006/0160699 A1
(43) Pub. Date: Jul. 20, 2006

(54) Support for image-recording material and method for producing the same

(75) Inventors: Shigehisa Tamagawa, Shizuoka-ken (JP); Yutaka Kubota, Shizuoka-ken (JP); Hiroshi Yamamoto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/334,368

(22) Filed: Jan. 19, 2006

(30) Foreign Application Priority Data
Jan. 20, 2005 (JP) 2005-13277

(51) Int. Cl. B41M 5/24; B41M 5/035

(52) U.S. Cl. 503/227

(57) ABSTRACT

A support for image-recording material, including a base paper prepared by using a pulp stock prepared by beating a pulp containing an LBKP having a length-weighted-average fiber length of 0.45 to 0.59 mm in an amount of 30% by mass or more to a Canadian Standard of Freeness (C.S.F) of 260 to 380 ml.

### CROSS-REFERENCE TO RELATED APPLICATION

This application claims priority under 35 USC 119 from Japanese Patent Application No. 2005-13277, the disclosure of which is incorporated by reference herein,

### BACKGROUND OF THE INVENTION

1. Field of the Invention

The present invention relates to a support for image-recording material and a production method thereof, and in particular to a support for image-recording material suited for constituting an image-recording material (e.g., photograph-like glossy paper) that records a photo-like high-quality image and a production method thereof.

2. Description of the Related Art

With the rapid progress of the information technology industry of recent years, various information processing systems have been developed. Recording methods and recording devices suitable for these information processing systems have also been developed and put to practical use in many fields.

As a practical recording method, in addition to silver salt photographic methods, there are electrophotographic methods, inkjet recording methods, thermal sensitive recording methods, sublimation transfer methods, thermal transfer methods and the like. With all of the above methods, there is the same requirement to obtain high quality images which are sharp, and have vivid coloring.

Inkjet recording methods have become widely used, not only in the office but also in the home, since the inkjet recording method enables recording to be performed on various recording materials, the hardware (device) is relatively inexpensive and compact, and operation is quiet. Moreover, with the higher resolution of inkjet printers in recent years, it is also possible to obtain high quality photo-like printed materials. Progress made in such hardware (devices) has also led to various kinds of inkjet recording sheets being developed.

For application to so-called photo-like glossy paper that is used for obtaining photo-like high-quality images, there are requirements in glossiness, surface smoothness, and texture similar to those for silver-salt photographic paper.

Although properties of a medium for inkjet recording, or a material to be recorded, have certain influence on recording of photo-like high-quality images, the properties of the base material (support) for inkjet-recording medium also have a great influence on the quality of the image formed thereon, and thus, it is essential to examine the properties of the base material itself for recording a high-quality photograph-like image. For example, the glossiness and flatness (smoothness) of the surface of base material and the degree of exfoliation (separation) of a laminated film, if present, from the surface thereof are the factors of great importance. In addition, the cut property (sharpness) when the base material is cut into pieces with a desirable size is preferably higher.

For improvement of the properties of base material (support), in particular of the glossiness and flatness (smoothness) of the surface thereof, the base material is commonly prepared with a pulp stock containing a pulp having a smaller weighted-average fiber length after beating (e.g., approximately 0.4 to 0.7 mm) (e.g., Japanese Patent Application Laid-Open (JP-A) Nos. 2-308242, 7-20604, and 10-104790). However, the reduction in fiber length (fibrillation) by beating alone was not effective enough for preparation of a base material having a highly smooth surface, and it was necessary to examine, for example, the composition of papermaking pulp stock, the length/width ratio of vessels, and others, in addition to fibrillation.

As described above, conventional methods of making paper from a pulp having a weighted-average fiber length shortened by beating, which has been widely studied, use a pulp stock prepared by using a pulp having a relatively longer weighted-average fiber length before beating (0.6 mm or more) and shortening the weighted-average fiber length thereof by beating or cutting after beating; and the base paper finally prepared by papermaking had a greater swelling/contraction and a significantly uneven surface in practice and was inadequate as a medium for recording a high-quality photographic image.

Alternatively, disclosed was a method of making paper by using a pulp prepared by beating a pulp having a longer weighted-average fiber length before beating (0.6 to 0.74 mm) into a pulp having a shorter weighted-average fiber length (0.45 to 0.60 mm) (e.g., JP-A No. 2000-10330).

As described above, although the conventional methods of making paper by using an LBKP containing a greater amount of short fibers having a weighted-average fiber length lowered by beating or cutting after beating are widely practiced in the art, they still had the problems that the base paper prepared after by beating an LBKP containing a greater amount of short fibers was still unsatisfactory for use as a medium for recording a high-quality photographic image in terms of surface glossiness and flatness, and that the resin film laminated on the surface thereof, if present, was separated easily. The base paper was also inferior in the cut property described above.

### SUMMARY OF THE INVENTION

The present invention, which has been made under the circumstances above, provides a support for image-recording material that is superior in cut property (sharpness), surface glossiness, smoothness, and laminatability (without spot-wise bumps) and a method of producing the support for image-recording material.

The inventors have found that use of a pulp stock containing a pulp (in particular, unbeaten pulp) having a shorter length-weighted-average fiber length in a particular amount together with beating of the pulp to a particular freeness are effective in giving a base paper superior in the glossiness and smoothness of its surface after papermaking and in preventing the exfoliation (spot-wise bumps) of its laminated film if present, and completed the invention based on the finding.

According to a first aspect of the invention, there is provided a support for image-recording material, including a base paper made by using a pulp stock prepared by beating a pulp containing an LBKP having a length-weighted-average fiber length of 0.45 to 0.59 mm in an amount of 30% by mass or more to a Canadian Standard of Freeness (C.S.F) of 260 to 380 ml.

According to a second aspect of the invention, there is provided the support for image-recording material described in the first aspect, wherein the LBKP is a maple LBKP.

According to a third aspect of the invention, there is provided the support for image-recording material described in the first aspect, wherein the amount of the LBKP is 50% by mass or more.

According to a fourth aspect of the invention, there is provided the support for image-recording material described in the first aspect, wherein the difference in the length-weighted-average fiber lengths between before and after beating is 0.05 mm or less.

According to a fifth aspect of the invention, there is provided the support for image-recording material described in the first aspect, wherein the base paper is made by using a paper machine equipped with a dandy roll.

According to a sixth aspect of the invention, there is provided the support for image-recording material described in the third aspect, wherein the base paper is made by using a paper machine equipped with a dandy roll.

According to a seventh aspect of the invention, there is provided the support for image-recording material described in the first aspect, wherein the pulp stock further contains an anionic colloidal silica.

According to an eighth aspect of the invention, there is provided the support for image-recording material described in the second aspect, wherein the pulp stock further contains an anionic colloidal silica.

According to a ninth aspect of the invention, there is provided the support for image-recording material described in the third aspect, wherein the pulp stock further contains an anionic colloidal silica.

According to a tenth aspect of the invention, there is provided the support for image-recording material described in the first aspect, wherein at least one surface of the base paper is coated with a polyolefin resin.

According to an eleventh aspect of the invention, there is provided the support for image-recording material described in the seventh aspect, wherein at least one surface of the base paper is coated with a polyolefin resin.

According to a twelfth aspect of the invention, there is provided the support for image-recording material described in the ninth aspect, wherein at least one surface of the base paper is coated with a polyolefin resin.

According to a thirteenth aspect of the invention, there is provided a material selected from an electrophotographic image-recording material, thermal-sensitive color-recording material, sublimation transfer image-recording material, thermal transfer image-recording material, silver salt photographic photosensitive material, and inkjet-recording medium using the support for image-recording material of the first aspect.

According to a fourteenth aspect of the invention, there is provided a material selected from an electrophotographic image-recording material, thermal-sensitive color-recording material, sublimation transfer image-recording material, thermal transfer image-recording material, silver salt photographic photosensitive material, and inkjet-recording medium using the support for image-recording material of the seventh aspect.

According to a fifteenth aspect of the invention, there is provided a material selected from an electrophotographic image-recording material, thermal-sensitive color-recording material, sublimation transfer image-recording material, thermal transfer image-recording material, silver salt photographic photosensitive material, and inkjet-recording medium using the support for image-recording material of the tenth aspect.

According to a sixteenth aspect of the invention, there is provided a material selected from an electrophotographic image-recording material, thermal-sensitive color-recording material, sublimation transfer image-recording material, thermal transfer image-recording material, silver salt photographic photosensitive material, and inkjet-recording medium using the support for image-recording material of the eleventh aspect.

According to a seventeenth aspect of the invention, there is provided a method of producing the support for image-recording material described in the first aspect, including preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.

According to an eighteenth aspect of the invention, there is provided a method of producing the support for image-recording material described in the ninth aspect, including preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.

According to a nineteenth aspect of the invention, there is provided a method of producing the support for image-recording material described in the twelfth aspect, including preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.

### DETAILED DESCRIPTION OF THE INVENTION

A pulp stock prepared by beating a short-fiber pulp having a length-weighted-average fiber length of 0.45 to 0.59 mm to a particular freeness is characteristically used in the present invention. Hereinafter, the support for image-recording material according to the invention and the production method thereof will be described in detail.

The support for image-recording material according to the invention is made of a base paper (hereinafter, referred to also as “base paper according to the invention”) prepared by using a pulp stock that is prepared by beating a pulp (hereinafter, referred to also as “pulp according to the invention”) containing an LBKP having a length-weighted-average fiber length of 0.45 to 0.59 mm (hereinafter, referred to as “LBKP according to the invention”) in an amount of 30% by mass or more to a freeness of 260 to 380 ml (C.S.F).

According to the invention, by using a paper stock prepared by beating a pulp (in particular, unbeaten pulp) containing an LBKP having a smaller length-weighted-average fiber length during preparation of the base paper, instead of using a paper stock containing a greater amount of short fibers prepared, for example, by beating or cutting after beating a pulp containing an LBKP having a relatively greater length-weighted-average fiber length (0.6 mm or more), it is possible to reduce the swelling/contraction of the base paper prepared. Therefore, it is possible to give a support paper superior in glossiness and surface smoothness without irregularity, and prevent spot-wise bumps, i.e., exfoliation (separation) of laminated film, effectively when the support is laminated. It is also effective in improving the sharpness of cut edge or the cut property.

The support for image-recording material according to the invention may be a support using only base paper as its base material, a support having a resin-coated layer of a polyolefin resin such as polyethylene formed on at least part of the surface of a base paper used as the base material, or a support having at least one layer such as undercoat layer formed on a base paper. When made only of a base material, the support may be made of the base paper according to the invention and may be a single-layered or multi-layered base paper.

Hereinafter, the base paper according to the invention will be described in detail. The base paper according to the invention is prepared by using a pulp containing an LBKP having a length-weighted-average fiber length of 0.45 to 0.59 mm (hardwood bleached kraft pulp). By using an LBKP having a length-weighted-average fiber length in the range above, which is shorter in length than conventional pulps, before it is beaten to a freeness in the range of 260 to 380 ml (C.S.F), it is possible to reduce the swelling/contraction of the base paper prepared, give a support superior in glossiness and surface smoothness, and prevent spot-wise bumps, i.e., exfoliation (separation) of laminated film, effectively when it is laminated.

In other words, when a pulp containing a length-weighted-average fiber length of less than 0.45 is used, spot-wise bumps tends to arise, and cannot obtain a highly glossy and smooth surface, and when a pulp containing a length-weighted-average fiber length of more than 0.59 mm is used, glossiness and smoothness are deteriorated, resulting in unfavorable flatness in the both cases. In particular, the length-weighted-average fiber length is preferably 0.50 to 0.59 mm.

In the invention, the “length-weighted-average fiber length” is determined according to the method described in JAPAN TAPPI, Paper and Pulp Test Method, No. 52:2000 (automatic optical analysis for determining the length of pulp, paper, or fiber). Specifically, the fiber length is determined by the number of photodiodes simultaneously detecting the images of pulp fibers, by using an optical analyzer, in which light emitted from a light source passes through lenses and filters such as an infrared ray absorption filter and a polarization filter, and fibers in an analytical cell, a perpendicular polarization filter disposed at the side opposite to the light-incident side of photocells a converging lens, and a measurement range-switching magnification lens and finally reaches a photocell. The length-weighted-average fiber length (L_{L}), which represents one of fiber lengths, is calculated from the measured data according to the following Formula:
L_{L}=(Σnᵢ·lᵢ²)/(Σnᵢ·lᵢ)
(nᵢ: number of fibers in fraction; and lᵢ: average length of fiber in fraction). In the invention, the fiber length is preferably determined by using, for example, a fiber length analyzer (trade name: Kajaani FS-200, manufactured by Valmet Corp.).

An LBKP (hardwood bleached kraft pulp) of the present invention includes aspen tree pulp, maple tree pulp, acacia tree pulp, poplar tree pulp and the like, and one kind of pulp may be used, or two or more kinds of pulps may be used in combination. Further, an NBKP (softwood bleached kraft pulp) such as spruce wood pulp other than the LBKP, or other wood pulps such as an LBSP, NBSP, LDP, NDP LUKP, NUKP and the like mat be used in combination. Among these pulps, maple tree pulp is preferable, and the maple tree pulp is used singly, or the maple tree pulp is preferably used in combination with one kind of the pulp or two or more kinds of pulps of other wood pulps.

The content of the LBKP in the base paper of the present invention is preferably 30% by mass or more. Namely, the content of the LBKP having a shorter weighted-average fiber length before beating in the present invention is higher than that of conventional base paper, so the ratio of swelling/contraction of the base paper can be reduced, and paper having a high glossiness and high smoothness can be obtained. Further, spot-wise bumps of the laminated surface can be effectively prevented. The above-mentioned content is more preferably 40% by mass or more, and still more preferably 50% by mass or more.

The freeness of the LBKP after beating for papermaking is preferably 260 to 380 ml as stipulated in Canadian Standard of Freeness (C. S. F.). In this range of freeness, the ratio of swelling/contraction of the base paper can be small, and paper having a high flatness (surface smoothness) can be obtained.

In other words, a freeness (C.S.F) of less than 260 ml results in a tendency for an increase in contraction making the support more shrinkable, deterioration in smoothness due to frequent occurrence of irregularity, and occurrence of frequent spot-wise bumps, while a freeness of more than 380 ml results in deterioration in formation because of improper dispersion and in the degree of glossiness and spot-wise bump. A freeness outside the range also results in deterioration in cut property. In the range above, the freeness is preferably 280 to 360 ml and more preferably 300 to 360 ml.

The freeness is a value determined according to the Canadian standard test method stipulated in JIS-P8121, “Testing Method of Determining Pulp Freeness”.

The pulp according to the invention is supplied as a pulp stock to papermaking after it is beaten to the freeness above, and the difference in the length-weighted-average fiber length of pulp before and after beating is preferably 0.05 mm or less.

When the difference is in the range above, it is possible to reduce the swelling/contraction and prevent the deterioration in smoothness associated with the unevenness due to a greater contraction. As a result, it is possible to reduce the swelling/contraction of a support having an excellent glossiness and surface smoothness, so that spot-wise bumps, i.e., exfoliation (separation) of laminated film are effectively prevented, when the base paper is laminated with a resin. The difference is particularly preferably 0.03 mm or less.

For example, for controlling the difference in the weighted-average fiber lengths by beating in the range above, it is preferable to select the width, angle and material of a blade for beating properly and adjust the rotational frequency of the blade, or to perform the beating stepwisely multiple times. For example, the power ratio of the first besting to the second beating in a two step beating is adjusted.

The fiber length in the pulp stock after beating is preferably controlled to a length at which the sum of a 24-mesh residue (% by mass) and a 42-mesh residue (% by mass) specified in JIS P-8207 is 30 to 70%. A 4-mesh residue (% by mass) is preferably 20% by mass or less.

As described above, the base paper according to the invention is prepared by using a pulp stock of the pulp according to the invention containing an LBKP having a relatively short-weighted-average fiber length (preferably, maple LBKP) after it is beaten to a particular freeness; the LBKP containing a small amount of impurities may also be used favorably; and it is also effective to use an LBKP improved in glossiness by bleaching.

The pulp stock may contain an anionic colloidal silica additionally. That is, it is preferable to make the base paper according to the invention after addition of an anionic colloidal silica. Presence of an anionic colloidal silica is effective in improving a dehydration efficiency (i.e., it functions as a freeness aid) and especially in improving the sharpness of cut edge, i.e., cut property.

The specific surface area of the anionic colloidal silica used is preferably in the range of 100 to 1000 m²/g, and the average particle diameter thereof is preferably in the rang, of 1 to 20 nm.

In view of improvement of the cut property and the dehydration efficiency, when colloidal silica is used, the content of the anionic colloidal silica is preferably 0.005 to 0.5% by mass, more preferably, 0.01 to 0.2% by mass, with respect to the amount of the pulp according to the invention.

The paper machine for making paper with the pulp stock prepared by beating the pulp according to the invention described above is not particularly limited, and any machine suitably selected from known paper machines may be used. An example thereof is a Fourdrinier machine equipped with a shaking device having a shaking width of 10 mm or more, and a paper machine having a dandy roll (e.g., paper machine having a dandy roll of 60- to 100-mesh wire) is preferable for improvement of the flatness.

Sizing agents such as a higher fatty acid and alkyl ketene dimer, white pigments such as calcium carbonate, talc and titanium oxide, paper reinforcing agents such as starch, polyacrylamide and polyvinyl alcohol, fluorescent optical brightening agents, water retention agents such as polyethylene glycols, dispersing agents, and softening agents such as a quaternary ammonium can be appropriately added to the base paper.

The basis weight of the base paper is preferably 30 to 250 g, and more preferably 50 to 200 g. The thickness of the base paper is preferably 40 to 250 μm.

High smoothness can be imparted to the base paper by calendar treatment at the making paper step or after paper making. The density of the base paper is generally 0.7 to 1.2 g/m² (JIS P-8118). In addition, the strength of the base paper is preferably 20 to 200 g under the conditions of JIS P-8143.

A surface size agent may be coated on the surface of the base paper, and a size agent which is the same as the size agent which can be added to the base paper can be used as the surface size agent. It is preferable that the pH of the base paper is 5 to 9 when measured by a hot water extraction method stipulated in JIS P-8113.

When the support for the image recording material of the present invention is formed by coating a resin on the surface of the base paper of the present invention, at least one of the front surface and the back surface of the base paper can be coated with a polyolefin resin (for example, polyethylene and polypropylene). The polyethylene mainly includes a low density polyethylene (LDPE) and/or high density polyethylene (HDPE), but others such as an LLDPE and polypropylene can be also used in part.

When a polyolefin layer composed of a polyolefin (for example, polyethylene), for example, a polyethylene layer is provided, the polyethylene layer on the side on which an image recording layer is formed preferably contains rutile type or anatase type titanium oxide, a fluorescent brightening agent or ultramarine blue pigment to improve opaqueness, whiteness and color hue, as is widely performed for photographic printing papers. Herein, the content of titanium oxide is preferably about 3 to 20% by mass, and more preferably 4 to 13% by mass relative to the amount of polyethylene.

The thickness of the polyethylene layer is not limited to a particular thickness, but preferably 10 to 50 μm for the both surfaces of the base paper.

Further, an undercoat layer can be formed on the polyolefin layer in order to impart adhesiveness of a recording layer (an ink receiving layer, for example, which will be described hereinafter, in the case of a support for an inkjet recording medium) for recording an image onto a support. An aqueous polyester, gelatin, and polyvinyl alcohol (PVA) are preferably used for the undercoat layer. The thickness of the undercoat layer is preferably 0.01 to 5 μm.

When the support for an image forming material of the present invention is a polyolefin (such as polyethylene) coated paper (such as polyethylene coated paper), the polyolefin coated paper may be used as a glossy paper. When polyethylene is coated on the base paper by melt-extrusion, the polyethylene coated paper can be used as a support which is used for an ordinary photographic printing paper which has a matte surface or silk surface by applying an embossing treatment.

A back coat layer can be provided on the surface of the support of the present invention, (in particular, a surface opposite to the surface on which a recording layer is formed when the support is used for an image forming material), and white pigments, aqueous binders and other components can be used as additive components of the back coat layer.

Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include antifoaming agents, foaming suppressing agents, dyes, fluorescent brighteners, preservatives and water-proofing agents.

The support for image-recording material according to the invention described above is most favorably prepared by processing at least once in the step of making the base paper according to the invention of making paper by beating a pulp stock of a pulp containing an LBKP having a length-weighted-average fiber length of 0.45 to 0.59 mm in an amount of 30% by mass or more to a freeness of 260 to 380 ml (C.S.F).

Details of the pulp stock such as the length-weighted-average fiber length, content, and freeness thereof and preferable embodiments thereof, paper machine, additives such as sizing agent, details of the resin coating thereof and preferable embodiments thereof, and others in preparing the support for image-recording material according to the invention are already described.

The preferred embodiments and applications of the support for image-recording material according to the invention are not particularly limited; but, it can be used favorably in various applications in which a high surface flatness, in particular, a high-glossiness and smoothness, a high lamination efficiency when a resin coated paper is prepared by subjecting a base paper to a resin laminating treatment, and a high-quality image recording are required. Specifically, the support can be used favorably as the inkjet-recording medium described below, as well as supporting materials such as an electrophotographic image-recording material, thermal sensitive color-recording material, sublimation transfer image-recording material, thermal-transfer image-recording material, silver salt photographic photosensitive material, and printing paper.

—Inkjet-Recording Medium—

The inkjet-recording medium has the support for image-recording material according to the invention described above and at least one ink receiving layer (recording layer), as well as another layer formed as needed on at least one face of the support; and an example thereof is a material used in the process of forming an image by ejecting an ink on the ink receiving layer and drying thereof. Generally, an inkjet printer is used for ejecting the ink. The ink receiving layer may be prepared by using at least inorganic or organic fine particles (preferably, silica fine particles) and a water-soluble resin (preferably, PVA or the like), and may contain as needed other components such as a crosslinking agent that crosslinks the water-soluble resin, mordant, and surfactant.

—Electrophotographic Image Receiving Materials—

The electrophotographic image receiving materials have a support for an image recording medium, and on at least one of the surfaces of the support at least one toner receiving layer (image recording layer), and other appropriate layers selected as required. For example, a surface protective layer, intermediate layer, undercoat layer, cushion layer, electrostatic charge adjustment (prevention) layer, reflective layer, color tint adjustment layer, preservability improvement layer, adhesion prevention layer, anti-curl layer, and/or a smoothing layer. Each of these layers can be a single layer structure or laminated structure.

—Silver Salt Photographic Photosensitive Materials—

A silver salt photographic photosensitive material is a material which has a structure having, for example, a support for an image recording medium of the present invention, and at least photosensitive layers thereon for forming colors of Y, M and C (image recording layers). The material is allowed to pass through a plurality of processing tanks after the material has been printing-exposed so that the exposed material is subjected to a color development, bleach-fixing and washing sequentially, and drying to form an image.

—Thermal Transfer Image Receiving Materials—

A thermal transfer image receiving materials is a material which has a structure having, for example, at least an image receiving layer (image recording layer) on a support for an image recording material of the invention, wherein thermal transfer material having at least a thermally fusible ink layer formed on a support is heated by using a thermal head so that the ink is fuse-transferred from the thermally fusible ink layer to the image receiving layer.

—Thermosenstive Color-Forming Recording Materials—

A thermosensitive color-forming recording material is a material for use in a thermo-autochrome (TA type) or the like, which has a structure having, for example, a thermal color-forming layer (image recording layer) on a support for an image recording medium of the invention, in which the recording material is subjected to heat by a thermal head and fixation with an ultraviolet ray or the like repeatedly to be thermally color-formed to form an image.

—Sublimation Transfer Image Receiving Materials—

A sublimation transfer image receiving material, is a material, for use in a sublimation transfer method, which has a structure having, for example, at least an image receiving layer (image recording layer) on a support for an image recording material of the invention, in which a sublimation transfer material having an ink layer containing at least a thermally diffusible dye (sublimating dye) provided on a support is heated by a thermal head to transfer the thermally diffusible dye on to the sublimation transfer image receiving material.

In the above-described inkjet recording medium, electrophotographic image receiving materials, thermosensitive color-forming recording materials, sublimation transfer image receiving materials, thermal transfer image receiving materials, or silver salt photographic materials, at least an image recording layer (ink receiving layer, toner image receiving layer, thermal color-forming layer, image receiving layer or photosensitive layer) of these materials is provided on a support of an image recording material or on an undercoat layer which constitutes the support of an image recording material of the present invention.

### EXAMPLES

Hereinafter, the present invention will be described with reference to Examples, but it should be understood that the invention is not restricted by these Examples. “%” in the following Examples means “% by mass,” unless specified otherwise.

### Example 1

A mixture of maple kraft pulp (LBKP according to the invention, length-weighted-average fiber length: 0.49 mm or less, referred to as pulp A) and acacia kraft pulp (LBKP, length-weighted-average fiber length: 0.67 mm or less, referred to as pulp C) (pulp A/pulp C=8/2 [weight ratio]) was beaten stepwise in two tandem double-disc refiners, to give a pulp slurry (pulp stock) having a Canadian Standard of Freeness (C.S.F) of 360 ml.

The length-weighted-average fiber length was determined by using a fiber length analyzer (trade name: Kajaani FS-200, manufactured by Valmet Corp.). The Canadian Standard of Freeness (C.S.F) was determined according to JIS-P8121, by using a Canadian Standard of Freeness tester (manufacture by Toyo Seiki Seisaku-sho Ltd.). The length-weighted-average fiber length of each pulp before and after beating and the change in length-weighted-average fiber length by beating are shown in the following Table 2.

Then, the pulp slurry was adjusted to a concentration of approximately 3.5%; an anionic polyacrylamide (acrylic acid/acrylamide=10/90 [molar ratio], average molecular weight about: 1,100,000), aluminum sulfate, polyamide polyamine epichlorohydrin, and epoxidized behenic acid amide of 1.0% 1.0%, 0.1%, and 0.5% respectively were added thereto; and the pulp slurry is adjusted to pH 7.0 by adding sodium hydroxide. A cationic polyacrylamide (molecular weight: 90,000, cation value: 2.8 ml/g) and an antifoam were added additionally, respectively at concentrations of 0.5% and 0.1%; and the mixture was agitated, to give a pulp slurry at a concentration of 1.0%; and then, an anionic colloidal silica (trade name: BMA-O, manufactured by Nissan-Eka Nobel Co. Ltd., 0.05%) was added, and the mixture was agitated. The slurry was then dehydrated and dried by using a Fourdrinier machine equipped with a shaking device having a shaking width of 20 mm, and sheeted into a base paper having a basis weight 160 g/m² and a thickness of 155 μm, to give a base paper for support. The amounts of the components added (%) were all absolute dry mass ratios with respect to the pulp (% to pulp).

The change of average fiber length by beating was controlled by adjusting the rotational frequency and the blade shape of double-disc refiner (blade width/groove width) and the power ratio between the first and second beating during two stepwise beating operations.

After the wire face of the base paper for support obtained was corona-discharged, a high density polyethylene film was formed thereon to a thickness of 33 μm by using a melt extruder. In addition, the felt face of the support base paper opposite to the coated face was corona-discharged, and a low-density polyethylene having a MFR (melt flow rate) of 3.8 containing anatase titanium dioxide (10%), a trace amount of ultramarine, and a fluorescent brightener (0.01%) (each, with respect to polyethylene) was coated to a thickness of 43 μm by using a melt extruder, to give a support according to the invention (support for image-recording material).

### Examples 2 to 7

Base papers for support were prepared by making a base paper having a basis weight of 166 g/m² and a thickness of 160 μm in a similar manner to Example 1, except that the kind, composition (weight ratio) and Canadian Standard of Freeness (C.S.F) of the pulp in the pulp mixture of Example 1 were change to those shown in the following Table 1 and the Fourdrinier machine was replaced with a Fourdrinier machine equipped with a dandy roll of 80-mesh wire (excluding Example 6); and then, supports according to the invention were prepared.

### Comparative Examples 1 to 7

Base papers for support were prepared by making a base paper having a basis weight of 165 g/m² and a thickness of 160 μm in a similar manner to Example 1, except that the kind, composition (weight ratio), and Canadian Standard of Freeness (C.S.F) of the pulp in the pulp mixture and presence or absence of the dandy roll in paper machine of Example 1 were change to those shown in the following Table 1; and then, comparative supports were prepared.

TABLE 1

| | | Average fiber length | | | | Change in | |
|---|---|---|---|---|---|---|---|
| | | of LBKP of | Freeness | Average fiber | Average fiber | average fiber | |
| | Pulp mixture (kinds / | Invention before | (C.S.F) | length before | length after | length by | Presence of |
| | mass ratio of pulps) | beating [mm] | [ml] | beating [mm] | beating [mm] | beating [mm] | dandy roll |
| Example 1 | Pulp A / Pulp C = 8 / 2 | Pulp A = 0.49 | 360 | 0.52 | 0.51 | 0.01 | N |
| Example 2 | Pulp A / Pulp C = 5 / 5 | Pulp A = 0.49 | 350 | 0.58 | 0.57 | 0.01 | Y |
| Example 3 | Pulp A / Pulp C = 6 / 4 | Pulp A = 0.49 | 280 | 0.56 | 0.52 | 0.04 | Y |
| Example 4 | Pulp A / Pulp D = 5 / 5 | Pulp A = 0.49 | 330 | 0.59 | 0.57 | 0.02 | Y |
| Example 5 | Pulp B / Pulp C = 7 / 3 | Pulp B = 0.58 | 300 | 0.61 | 0.59 | 0.02 | Y |
| Example 6 | Pulp B / Pulp E = 4 / 6 | Pulp B = 0.58 | 340 | 0.64 | 0.59 | 0.05 | N |
| Example 7 | Pulp B / Pulp E = 4 / 6 | Pulp B = 0.58 | 340 | 0.64 | 0.59 | 0.05 | Y |
| Comparative Example 1 | Pulp A / Pulp D = 1 / 9 | Pulp A = 0.49 | 400 | 0.69 | 0.68 | 0.01 | N |
| Comparative Example 2 | Pulp A / Pulp C = 8 / 2 | Pulp A = 0.49 | 400 | 0.52 | 0.48 | 0.04 | Y |
| Comparative Example 3 | Pulp A / Pulp C = 8 / 2 | Pulp A = 0.49 | 240 | 0.52 | 0.44 | 0.08 | N |
| Comparative Example 4 | Pulp C / Pulp D = 5 / 5 | — | 300 | 0.69 | 0.59 | 0.10 | Y |
| Comparative Example 5 | Pulp D / Pulp E = 5 / 5 | — | 200 | 0.70 | 0.57 | 0.13 | N |
| Comparative Example 6 | Pulp C / Pulp E = 5 / 5 | — | 450 | 0.68 | 0.66 | 0.02 | N |
| Comparative Example 7 | Pulp D / Pulp F = 8 / 2 | — | 350 | 0.81 | 0.81 | 0.03 | N |

* The average fiber length is a “length-weighted-average fiber length”.

The pulps A to F in Table 1 are as follows:
Pulp A: Length-weighted-average fiber length: 0.49 mm (maple LBKP)
Pulp B: Length-weighted-average fiber length: 0.58 mm (maple LBKP)
Pulp C: Length weighted-average fiber length: 0.67 mm (acacia LBKP)
Pulp D: Length-weighted-average fiber length: 0.71 mm (aspen LBKP)
Pulp E: Length-weighted-average fiber length 0.69 mm (poplar LBKP)
Pulp F: Length-weighted-average fiber length 1.2 mm (spruce NBKP)

(Evaluation)

The support according to the invention and comparative supports thus obtained were respectively evaluated as follows. Evaluation results are shown in the following Table 2.

1. Glossiness (Image Clarity)

The 60° image clarity C value of the surface of each support was determined by using an image clarity meter (trade name: ICM-1, manufactured by Suga Test Instrument Co., Ltd.) (comb width: 2 mm). Results were grouped into five ranks according to the following criteria: when C>60, “5”; when 60≧C>55, “4”; when 55≧C>50, “3”; when 50≧C>45, “2”; and when C≦45, “1”.

2. Surface Smoothness

The average central-face roughness S of each support was determined by using a profilometer (trade name: Nanometro 110F, manufactured by Kuroda Precision Industries Ltd.) at a cut-off length of 1 to 3 mm, and was used as an indicator of the smoothness of the support surface (surface smoothness). The observed values were grouped into five ranks: when S<0.30, “5”; when 0.30≦S<0.33, “4”; when 0.33≦S<0.35, “3”; when 0.35≦S<0.40 “2”; and 0.40≦S, “1”.

3. Spot-Wise Bump

Presence of scattered spots swollen with air formed by separation between the resin film and the support (spot-wise bump) on each support was observed visually. The results were grouped into five ranks: no bump, “5”; scattered bumps but without practical problem, “4”; distinct generation of bumps with practical problem, “3”; many bumps, “2”, and significant generation of bumps, “1”; and were used as an indicator of laminatability.

4. Cut Property (Sharpness of Cut Edge)

Each support was cut by using an automatic cutter (trade name: FCT30K, manufactured by Fuji Photo Film Co., Ltd.). The results of the cutting test were grouped into five ranks: with almost no fluffing, “5”, with slight fluffing, but in the allowable range, “4”, with fluffing, and outside the practically allowable range, “3”, with distinct fluffing, “2”, and with significant fluffing, “1”, and were used as an indicator of the cut property.

TABLE 2

| | | | Spot-wise | |
|---|---|---|---|---|
| | Glossiness | Smoothness | bump | Cut property |
| Example 1 | 5 | 5 | 4 | 4 |
| Example 2 | 5 | 5 | 5 | 5 |
| Example 3 | 5 | 5 | 5 | 5 |
| Example 4 | 5 | 5 | 5 | 5 |
| Example 5 | 5 | 5 | 4 | 5 |
| Example 6 | 4 | 4 | 5 | 5 |
| Example 7 | 4 | 5 | 5 | 5 |
| Comparative | 3 | 3 | 4 | 5 |
| Example 1 | | | | |
| Comparative | 3 | 5 | 2 | 3 |
| Example 2 | | | | |
| Comparative | 5 | 3 | 3 | 4 |
| Example 3 | | | | |
| Comparative | 3 | 3 | 5 | 5 |
| Example 4 | | | | |
| Comparative | 4 | 2 | 5 | 5 |
| Example 5 | | | | |
| Comparative | 3 | 2 | 3 | 3 |
| Example 6 | | | | |
| Comparative | 2 | 1 | 4 | 3 |
| Example 7 | | | | |

As shown in Table 2 above, the supports according to the invention were superior in glossiness and smoothness and also favorable in laminatability because spot-wise bump is suppressed. They were also favorable in cut property. Thus, the supports according the invention are favorably used for photographic-like high-glossiness, high-quality image recording.

In contrast, the comparative supports could not satisfy the requirements in high glossiness, cut property, and flatness at the same time. In particular, when the length-weighted-average fiber length deviated from the range specified in the invention (0.45 to 0.59 mm), the support had a greater swelling/contraction and thus, was significantly inferior in the glossiness and smoothness of its surface. In addition, when the freeness is excessively great (Comparative Example 2), the support was inferior significantly in glossiness and spot-wise bump (laminatability) even when the pulp according to the invention was used, while when the freeness is too smaller (e.g., Comparative Examples 3 and 5), the supports were inferior in surface smoothness.

The invention provides a support for image-recording material superior in cut property (sharpness), glossiness, surface smoothness, and laminatability (without spot-wise bump), and a method of producing the support for image-recording material.

What is claimed is:

1. A support for image-recording material, comprising a base paper prepared by sheeting a pulp stock prepared by beating a pulp containing an LBKP having a length-weighted-average fiber length of 0.45 to 0.59 mm in an amount of 30% by mass or more to a Canadian Standard of Freeness (C.S.F) of 260 to 380 ml.

2. The support for image-recording material of claim 1, wherein the LBKP is a maple LBKP.

3. The support for image-recording material of claim 1, wherein the amount of the LBKP is 50% by mass or more.

4. The support for image-recording material of claim 1, wherein the difference in the length-weighted-average fiber lengths between before and after beating is 0.05 mm or less.

5. The support for image-recording material of claim 1, wherein the base paper is made by using a paper machine equipped with a dandy roll.

6. The support for image-recording material of claim 3, wherein the base paper is made by using a paper machine equipped with a dandy roll.

7. The support for image-recording material of claim 1, wherein the pulp stock further contains an anionic colloidal silica.

8. The support for image-recording material of claim 2, wherein the pulp stock further contains an anionic colloidal silica.

9. The support for image-recording material of claim 3, wherein the pulp stock further contains an anionic colloidal silica.

10. The support for image-recording material of claim 1, wherein at least one surface of the base paper is coated with a polyolefin resin.

11. The support for image-recording material of claim 7, wherein at least one surface of the base paper is coated with a polyolefin resin.

12. The support for image-recording material of claim 9, wherein at least one surface of the base paper is coated with a polyolefin resin.

13. A material selected from electrophotographic image-recording material, thermal-sensitive color-recording material, sublimation transfer image-recording material, thermal transfer image-recording material, silver salt photographic photosensitive material, and inkjet-recording medium using the support for image-recording material of claim 1.

14. A material selected from electrophotographic image-recording material, thermal-sensitive color-recording material, sublimation transfer image-recording material, thermal transfer image-recording material, silver salt photographic photosensitive material, and inkjet-recording medium using the support for image-recording material of claim 7.

15. A material selected from electrophotographic image-recording material, thermal-sensitive color-recording material, sublimation transfer image-recording material, thermal transfer image-recording material, silver salt photographic photosensitive material, and inkjet-recording medium using the support for image-recording material of claim 10.

16. A material selected from electrophotographic image-recording material, thermal-sensitive color-recording material, sublimation transfer image-recording material, thermal transfer image-recording material, silver salt photographic photosensitive material, and inkjet-recording medium using the support for image-recording material of claim 11.

17. A method of producing the support for image-recording material of claim 1, comprising preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.

18. A method of producing the support for image-recording material of claim 9, comprising preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.

19. A method of producing the support for image-recording material of claim 12, comprising preparing a pulp stock by beating a pulp containing an LBKP having a length-weighted-average fiber length of 0.45 to 0.59 mm in an amount of 30% by mass or more to a freeness of 260 to 380 ml (C.S.F) and making a base paper by using the pulp stock.
